(19) United States
(12) Patent Application Publication
(10) Pub. No.: US 2020/0028737 A1
(43) Pub. Date: Jan. 23, 2020

(54) METHOD AND DEVICE FOR UPGRADING MODULE FIRMWARE OF POS MACHINE

(71) Applicant: PAX COMPUTER TECHNOLOGY (SHENZHEN) CO., LTD., Shenzhen, Guangdong (CN)

(72) Inventors: Chuan LIU, Shenzhen (CN); Xin LI, Shenzhen (CN); Yanfei WANG, Shenzhen (CN); Ruzhen HUANG, Shenzhen (CN)

(73) Assignee: Pax Computer Technology (Shenzhen) Co., Ltd., Shenzhen, Guangdong (CN)

(21) Appl. No.: 15/744,136

(22) PCT Filed: Aug. 2, 2017
(86) PCT No.: PCT/CN2017/095691

§ 371 Date: Aug. 30, 2018

(30) Foreign Application Priority Data
Feb. 23, 2017 (CN) 201710101684.8

(51) Int. Cl. H04L 12/24; G06F 8/65; G06F 21/57; H04L 29/08; H04L 29/06; G06F 8/71; H04L 9/32

(52) U.S. Cl. CPC H04L 41/082; G06F 8/65; G06F 21/572; H04L 67/025; H04L 63/12; G06F 8/71; H04L 9/3247; H04L 67/34

(57) ABSTRACT

The present disclosure relates to the technical field of payment terminals and provides a method and a device for upgrading a module firmware of a POS machine in order to improve safety of the POS machine when upgrading the module firmware. The method comprises: downloading a module firmware upgrade package; verifying a signature of the module firmware upgrade package; and decompressing the module firmware upgrade package to perform subsequent upgrading of a module firmware if a verification of the signature of the module firmware upgrade package is successful, or otherwise, returning information that the verification fails.

### TECHNICAL FIELD

The present application relates to the technical field of payment terminals, particularly to a method and device for upgrading a module firmware of a POS machine.

### BACKGROUND

A point of sale (POS) machine includes multiple modules, such as a magnetic stripe card reader, a contact IC card reader, a non-contact IC card reader, Wifi, Bluetooth, 2G, 3G, 4G, a camera, a printer, and a barcode scanning head, etc. In these modules, some modules, such as the contact IC card reader and the non-contact IC card reader, do not have any inherent firmware and operates under the driving of an operating system (OS), and upgrading of the firmware of these modules is always performed by the OS; while other modules, like 2G, 3G, 4G modules, have firmware as well as Flash storing the firmware inherently, such modules are connected with the POS machine, such as via a series interface and a USB, and the firmware thereof needs to be separately downloaded.

When dealing with the upgrading of the firmware for the current POS machines on the market, a generally method is to connect the POS machine with a computer, operate a tool provided by a module manufacturer, and download the firmware of the module into corresponding module. Because the firmware is separately downloaded without performing signature verification, regarding the above method of firmware upgrading, if an upgrade protocol of the module manufacturer is leaked, the upgrade tool may be forged, it is possible that the firmware of the module is illegally upgraded, resulting in leakage of communication data and having safety risk.

### SUMMARY

It is one object of the present application to provide a method and a device for upgrading a module firmware of a POS machine, so as to improve the safety of the POS machine when upgrading the module firmware.

A first aspect of the present application is to provide a method for upgrading a module firmware of a POS machine, and the method comprises:

downloading a module firmware upgrade package, i.e., a module FWP;

verifying a signature of the module firmware upgrade package; and

decompressing the module firmware upgrade package to perform subsequent upgrading of a module firmware, if a verification of the signature of the module firmware upgrade package is successful; or otherwise, returning information that the verification fails.

A second aspect of the present application is to provide a device for upgrading a module firmware of a POS machine, and the device comprises:

a download module configured to download a module firmware upgrade package;

a first verification module configured to verify a signature of the module firmware upgrade package; and

a decompression module configured to decompress the module firmware upgrade package to perform subsequent upgrading of a module firmware if a verification of the signature of the module firmware upgrade package is successful; or otherwise, return information showing that the verification fails.

From the above technical solution of the present application, it can be known that: the upgrade package of the module firmware has been performed with signature verification and the upgrade package of the module firmware is decompressed only after successful verification, therefore, there is low coupling between the module firmware upgrade package design and the OS, and the OS does not require to upgrade whether because the module firmware is upgraded or the download protocol is changed, thereby lowing the cost required for the upgrading of the module firmware; on the other hand, the upgrade safety is improved, such that the loss of the POS machine users caused by forged upgrade tools can be effectively prevented.

### BRIEF DESCRIPTION OF THE DRAWINGS

FIG. 1 is a structural diagram of an implementation flow of a method for upgrading a module firmware of a POS machine provided by a first embodiment of the present application;

FIG. 2 is a structural schematic diagram of a device for upgrading a module firmware of a POS machine provided by a second embodiment of the present application;

FIG. 3 is a structural schematic diagram of a device for upgrading a module firmware of a POS machine provided by a third embodiment of the present application;

FIG. 4 is a structural schematic diagram of a device for upgrading a module firmware of a POS machine provided by a fourth embodiment of the present application;

FIG. 5-a is a structural schematic diagram of a device for upgrading a module firmware of a POS machine provided by a fifth embodiment of the present application;

FIG. 5-b is a structural schematic diagram of a device for upgrading a module firmware of a POS machine provided by a sixth embodiment of the present application; and

FIG. 5-c is a structural schematic diagram of a device for upgrading a module firmware of a POS machine provided by a seventh embodiment of the present application.

### DETAILED DESCRIPTION OF THE EMBODIMENTS

In order to make the purposes, technical solutions, and advantages of the present invention clearer and more understandable, the present application is further described in detail hereinafter with reference to the accompanying drawings and embodiments. It should be understood that the embodiments described herein are only intended to illustrate but not to limit the present application.

A method for upgrading a module firmware of a POS machine is provided by embodiments of the present application, and the method comprises: downloading a module firmware upgrade package; verifying a signature of the module firmware upgrade package; and decompressing the module firmware upgrade package to perform subsequent upgrading of a module firmware if a verification of the signature of the module firmware upgrade package is successful, or otherwise, returning information that the verification fails. The steps are respectively described in detail hereinafter.

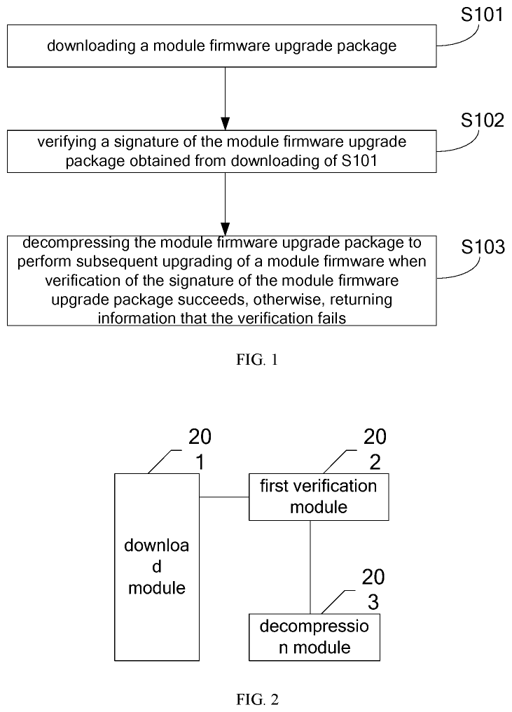

Please refer to FIG. 1, which is a flow structural diagram of implementation of a method for upgrading a module firmware of a POS machine provided by a first embodiment of the present application. The method mainly comprises steps S101-S103, which are described in detail as follows:

S101, downloading the module firmware upgrade package.

In this embodiment of the present application, the upgrade package of the module firmware is compressed into a whole package by adopting the form of.tar or.gz that is common in linux, and is signed with the same key as a signature of the firmware of the OS, thereby ensuring that the module firmware upgrade package can only be issued by the POS machine manufacturer and will not be tampered. The module firmware upgrade package comprises three members, which are respectively a module firmware, an upgrade program and an information file of the module firmware upgrade package, wherein, the module firmware is a firmware of a module of the POS machine provided by the module manufacturer; the upgrade program functions in executing downloading of the module firmware and mainly comprises a downloading protocol provided by the module manufacturer, moreover, different modules correspond to different downloading protocol and the upgrade program of each module firmware upgrade package is also different; the information file of the module firmware upgrade package records three fields including the module identification, a version number of the module firmware to be upgraded, and description information, wherein, the field of the module identification can be a module code or a real name of the module and is required to be consistent with the name of the module in the POS machine, the field of the version number of the module firmware to be upgraded represents a version of the module firmware to be upgraded and is required to be consistent with the version number of the module read from the POS machine after the module upgrades the firmware, and the field of the description information describes basic information of the module, which comprises an actual name and a support models and enables users to know the basic information of the module firmware upgrade package intuitively.

As an embodiment of the present application, the downloading the upgrade package of the module firmware can be locally downloading the module firmware upgrade package or remotely downloading the module firmware upgrade package, of which, the local downloading the module firmware upgrade package can be wiredly or wirelessly connecting to a server and downloading the module firmware upgrade package, for example, connecting to a server of the internet via a wireless mode, for example, WiFi, 2G, 3G, or 4G, etc., and downloading the module firmware upgrade package, or connecting to a computer terminal via the ethernet or a USB and downloading the module firmware upgrade package from the server of the internet.

In this embodiment of the present application, because the module firmware upgrade package can be remotely downloaded to perform the upgrading of the module firmware, it is not required to manage maintenance personals of the POS machines to upgrade the module firmware on site, thereby greatly saving labor cost.

S102, verifying the signature of the module firmware upgrade package obtained from downloading of S101.

As described in the above, in this embodiment of the present application, the module firmware upgrade package is signed with the same key as the signature of the firmware of the OS. Thus, in order to ensure the safety of the upgrading of the module firmware, the signature of the module firmware upgrade package acquired from the downloading of S101 is verified.

S103, decompressing the module firmware upgrade package to perform subsequent upgrading of the module firmware if a verification of the signature of the module firmware upgrade package is successful; or otherwise, returning information that the verification fails.

In this embodiment of the present application, after decompressing the module firmware upgrade package to perform subsequent upgrading of the module firmware, the method further comprises steps S104-S106, which are described as follows:

S104, determining whether a current POS machine comprises a module corresponding to the module identification;

It should be noted that, in this embodiment of the present application, the POS machine has multiple kinds of peripheral modules, each kind of peripheral module also has multiple modules, and a version of each firmware of each module corresponds to a module firmware upgrade package. Theoretically, the upgrade program in the module firmware upgrade package is implemented when a first module firmware upgrade package of one module is generated, the upgrade program is not required to be changed due to the subsequent upgrade of the firmware of the module, and only the information file of the module firmware upgrade package and the module firmware are upgraded. In the current supported peripheral module, the firmware of the OS is relatively large, which is far larger than the module firmware, generally, there is no need to upgrade the OS, even the module firmware upgrade package is upgraded (for example, upgrading of the firmware, change of the protocol, and existence of Bug in development) due to different reasons, the OS will not require synchronous upgrading.

S105, verifying a signature of the upgrade program.

Since the system will verify signatures of all executable files, in this embodiment of the present application, the upgrade program is also signed and a signature key thereof is consistent with that of the whole module firmware upgrade package, thus, the signature of the upgrade program is verified, thereby avoiding being forged or tempered.

S106, operating the upgrade program to upgrade the module firmware if the current POS machine comprises the module corresponding to the module identification and the verification of the signature of the upgrade program is successful.

If the current POS machine comprises the module corresponding to the module identification and the verification of the signature of the upgrade program is successful, after operating the upgrade program to upgrade the module firmware, the method further comprising: reading a version number of the module firmware to be upgraded in the current POS machine; comparing the version number of the module firmware to be upgraded in the current POS machine with the version number of the module firmware to be upgraded contained in the information file of the module firmware upgrade package; and prompting that the upgrading of the module firmware is successful if the version number of the module firmware to be upgraded in the current POS machine is consistent with the version number of the module firmware to be upgraded contained in the information file of the module firmware upgrade package, or otherwise, prompting that the upgrading of the module firmware fails.

If the current POS machine does not comprises the module corresponding to the module identification and/or the verification of the signature of the upgrade program fails, the upgrade process is exited and prompting information including false of unmatched module and/or false of signature failure, etc., are returned.

From the method for upgrading the module firmware of the POS machine exemplified in FIG. 1, it is known that: the upgrade package of the module firmware has been performed with signature verification and the upgrade package of the module firmware is decompressed only after successful verification, therefore, there is low coupling between the module firmware upgrade package design and the OS, and the OS does not require to upgrade whether because the module firmware is upgraded or the download protocol is changed, thereby lowing the cost required for the upgrading of the module firmware; on the other hand, the upgrade safety is improved, such that the loss of the POS machine users caused by forged upgrade tools can be effectively prevented.

Please refer to FIG. 2, which is a structural schematic diagram of a device for upgrading a module firmware of a POS machine provided by a second embodiment of the present application. For facilitating the description, FIG. 2 only shows parts related to this embodiment of the present application. The device for upgrading the module firmware of the POS machine can be an execution subject of the method for upgrading the module firmware of the POS machine and mainly comprises a download module 201, a first verification module 202, and a decompression module 203, which are described in detail as follows:

the download module 201 is configured to download a module firmware upgrade package;

the first verification module 202 is configured to verify a signature of the module firmware upgrade package; and

the decompression module 203 is configured to: decompress the module firmware upgrade package to perform subsequent upgrading of a module firmware if a verification of the signature of the module firmware upgrade package is successful; or otherwise, return information showing that the verification fails.

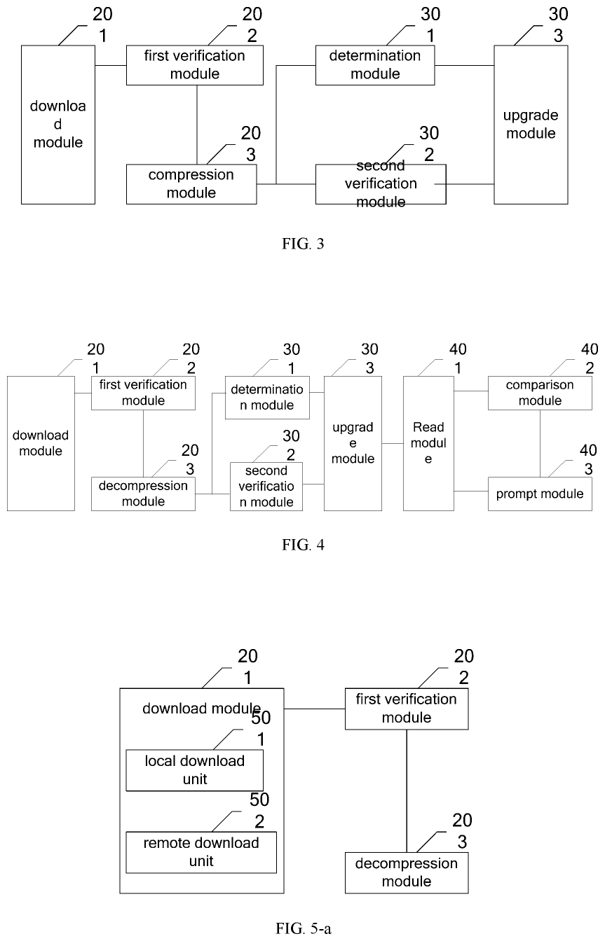

In the device exemplified in FIG. 2, the module firmware upgrade package comprises an upgrade program and an information file of the module firmware upgrade package, the information file of the module firmware upgrade package comprises a module identification, and the device for upgrading the module firmware of the POS machine exemplified in FIG. 2 further comprises: a determination module 301, a second verification module 302, and an upgrade module 303; and a device for upgrading a module firmware of a POS machine provide by a third embodiment of the present application is shown in FIG. 3, wherein:

a determination module 301 is configured to determine whether a current POS machine comprises a module corresponding to the module identification after decompressing the module firmware upgrade package by the compression module 203 to perform subsequent upgrading of the module firmware;

a second verification module 302 is configured to verify a signature of the upgrade program; and

an upgrade module 303 is configured to operate the upgrade program to upgrade the module firmware, if the current POS machine comprises the module corresponding to the module identification and the verification of the signature of the upgrade program is successful.

In the device exemplified in FIG. 3, the information file of the module firmware upgrade package further comprises a version number of a module firmware to be upgraded, the device for upgrading the module firmware of the POS machine further comprises a read module 401, a comparison module 402, and a prompt module 403; a device for upgrading a module firmware of a POS machine provide by a fourth embodiment of the present application is shown in FIG. 4, wherein:

a read module 401 is configured to read a version number of the module firmware to be upgraded in the current POS machine after operating the upgrade program by the upgrade module 303 to upgrade the module firmware;

a comparison module 402 configured to compare the version number of the module firmware to be upgraded in the current POS machine with the version number of the module firmware to be upgraded contained in the information file of the module firmware upgrade package; and

a prompt module 403 configured to prompt that the upgrading of the module firmware is successful if the version number of the module firmware to be upgraded in the current POS machine is consistent with the version number of the module firmware to be upgraded contained in the information file of the module firmware upgrade package, or otherwise prompt that the upgrading of the module firmware fails.

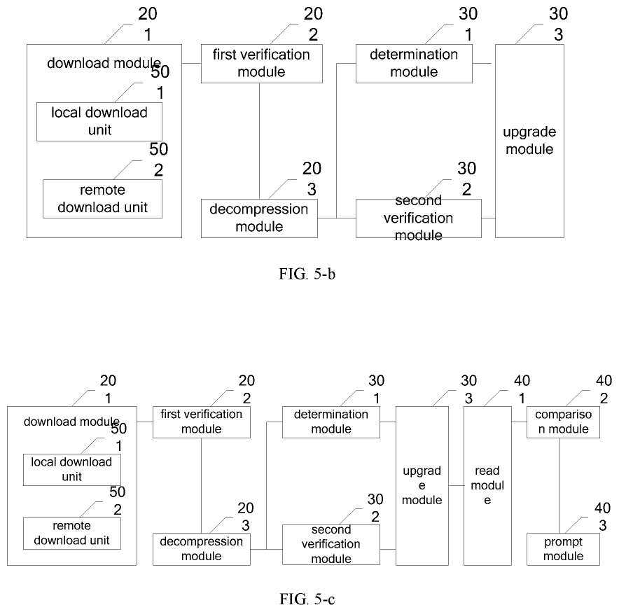

The download module 201 exemplified in any of FIGS. 2-4 further comprises a local download unit 501 or a remote download unit 502, the devices for upgrading the module firmware of the POS machine provided by a fifth embodiment to a seventh embodiment of the present application are as shown in FIGS. 5-a to 5-c, of which:

the local download unit 501 is configured to locally download the module firmware upgrade package; and

the remote download unit 502 is configured to remotely download the module firmware upgrade package.

In the device for upgrading the module firmware of the POS machine as shown in FIGS. 5-a to 5-c, the remote download unit 502 is specifically configured to wiredly or wirelessly connect to a server and to download the module firmware upgrade package.

It should be noted that the contents of information interaction between different modules/units and execution process of the above device, because based on the same concept of the embodiments of the method of the present application, the technical effects of the device is the same as that of the embodiments of the method of the present application, specific contents can refer to the description of the embodiments of the method of the present application and will not be repeated herein.

It can be understood by persons of ordinary skills in the art that all or a part of the steps in the method in the foregoing embodiments may be implemented by instructing relevant hardware by a program. The program can be stored in a computer readable storage medium, and the storage medium can include: a read only memory (ROM), a random access memory (RAM), a magnetic disk, and an optical disk, etc.

The method and the device for upgrading the module firmware of the POS machine provided in the embodiments of the present application are described in detail in the above. Specific examples are used herein to describe the principle and implementation modes of the present application. The description of the foregoing embodiments is merely used to help understand the method and essential idea of the present application. Meanwhile, for those skilled in the art, both the specific implementation modes and application scopes may change according to the present application. In summary, the content of the specification should not be construed as limitation of the present application.

1. A method for upgrading a module firmware of a point of sale (POS) machine, comprising:
downloading a module firmware upgrade package;
verifying a signature of the module firmware upgrade package; and
decompressing the module firmware upgrade package to perform subsequent upgrading of a module firmware if a verification of the signature of the module firmware upgrade package is successful; or otherwise, returning information showing that the verification fails.

2. The method of claim 1, wherein the module firmware upgrade package comprises an upgrade program and an information file of the module firmware upgrade package, the information file of the module firmware upgrade package comprises a module identification, the method further comprises, after decompressing the module firmware upgrade package to perform subsequent upgrading of the module firmware:
determining whether a current POS machine comprises a module corresponding to the module identification;
verifying a signature of the upgrade program; and
operating the upgrade program to upgrade the module firmware, if the current POS machine comprises the module corresponding to the module identification and the verification of the signature of the upgrade program is successful.

3. The method of claim 2, wherein the information file of the module firmware upgrade package further comprises a version number of a module firmware to be upgraded, the method further comprising, after operating the upgrade program to upgrade the module firmware,
reading a version number of the module firmware to be upgraded in the current POS machine;
comparing the version number of the module firmware to be upgraded in the current POS machine with the version number of the module firmware to be upgraded contained in the information file of the module firmware upgrade package; and
prompting that the upgrading of the module firmware is successful, if the version number of the module firmware to be upgraded in the current POS machine is consistent with the version number of the module firmware to be upgraded contained in the information file of the module firmware upgrade package; or otherwise, prompting that the upgrading of the module firmware fails.

4. The method of claim 1, wherein the downloading of the upgrade package of the module firmware comprises locally downloading the module firmware upgrade package or remotely downloading the module firmware upgrade package.

5. The method of claim 4, wherein the locally downloading of the module firmware upgrade package comprises wiredly or wirelessly connecting to a server and downloading the module firmware upgrade package.

6. A device for upgrading a module firmware of a POS machine, comprising:
a download module configured to download a module firmware upgrade package;
a first verification module configured to verify a signature of the module firmware upgrade package; and
a decompression module configured to decompress the module firmware upgrade package to perform subsequent upgrading of a module firmware if a verification of the signature of the module firmware upgrade package is successful; or otherwise, to return information showing that the verification fails.

7. The device of claim 6, wherein the module firmware upgrade package comprises an upgrade program and an information file of the module firmware upgrade package, the information file of the module firmware upgrade package comprises a module identification, and the device further comprises:
a determination module configured to determine whether a current POS machine comprises a module corresponding to the module identification, after decompressing the module firmware upgrade package by the compression module to perform subsequent upgrading of the module firmware;
a second verification module configured to verify a signature of the upgrade program; and
an upgrade module configured to operate the upgrade program to upgrade the module firmware if the current POS machine comprises the module corresponding to the module identification and the verification of the signature of the upgrade program is successful.

8. The device of claim 7, wherein the information file of the module firmware upgrade package further comprises a version number of a module firmware to be upgraded, and the device further comprises:
a read module configured to read a version number of the module firmware to be upgraded in the current POS machine after operating the upgrade program by the upgrade module to upgrade the module firmware;
a comparison module configured to compare the version number of the module firmware to be upgraded in the current POS machine with the version number of the module firmware to be upgraded contained in the information file of the module firmware upgrade package; and
a prompt module configured to prompt that the upgrading of the module firmware is successful, if the version number of the module firmware to be upgraded in the current POS machine is consistent with the version number of the module firmware to be upgraded contained in the information file of the module firmware upgrade package; or otherwise, to prompt that the upgrading of the module firmware fails.

9. The device of claim 6, wherein the downloading module comprises a local download unit or a remote download unit;
the local download unit configured to locally download the module firmware upgrade package; and
the remote download unit configured to remotely download the module firmware upgrade package.

10. The device of claim 9, wherein the remote download unit is configured to wiredly or wirelessly connect to a server and to download the module firmware upgrade package.

11. The method of claim 2, wherein the downloading of the upgrade package of the module firmware comprises locally downloading the module firmware upgrade package or remotely downloading the module firmware upgrade package.

12. The method of claim 11, wherein the locally downloading of the module firmware upgrade package comprises wiredly or wirelessly connecting to a server and downloading the module firmware upgrade package.

13. The method of claim 3, wherein the downloading of the upgrade package of the module firmware comprises locally downloading the module firmware upgrade package or remotely downloading the module firmware upgrade package.

14. The method of claim 13, wherein the locally downloading of the module firmware upgrade package comprises wiredly or wirelessly connecting to a server and downloading the module firmware upgrade package.

15. The device of claim 7, wherein the downloading module comprises a local download unit or a remote download unit;
the local download unit configured to locally download the module firmware upgrade package; and
the remote download unit configured to remotely download the module firmware upgrade package.

16. The device of claim 15, wherein the remote download unit is configured to wiredly or wirelessly connect to a server and to download the module firmware upgrade package.

17. The device of claim 8, wherein the downloading module comprises a local download unit or a remote download unit;
the local download unit configured to locally download the module firmware upgrade package; and
the remote download unit configured to remotely download the module firmware upgrade package.

18. The device of claim 17, wherein the remote download unit is configured to wiredly or wirelessly connect to a server and to download the module firmware upgrade package.
